(19) United States
(12) Patent Application Publication
(10) Pub. No.: US 2026/0122035 A1
(43) Pub. Date: Apr. 30, 2026

(54) METHOD AND SYSTEM FOR IMPLEMENTING DATA GUARDS USING MULTIPLE SUB-ELEMENT IMPLEMENTATION REPOSITORIES

(71) Applicant: ROCKWELL COLLINS, INC., Cedar Rapids, IA (US)

(72) Inventor: Sean D. HOWARD, Cedar Rapids, IA (US)

(73) Assignee: ROCKWELL COLLINS, INC., Cedar Rapids, IA (US)

(21) Appl. No.: 18/931,361

(22) Filed: Oct. 30, 2024

(51) Int. Cl. H04L 9/40

(52) U.S. Cl. CPC H04L 63/0236; H04L 63/0263

(57) ABSTRACT

A data guard is used to enable communication between a variety of networks having different levels of security classifications. Guard executable code is generated that is unique to the data guard using a stitcher, a previous combinations database, and at least three repositories. The stitcher generates a random seed that is used to retrieve a combination of implementations of methods for use within the data guard from the previous combinations database. Each implementation of the combination of implementations is provided to the stitcher from the appropriate repository. The stitcher combines the different implementations into a guard code base. The guard code base including the combination of implementations is used by a compiler to generate the guard executable code.

### FIELD OF THE INVENTION

The subject matter disclosed herein relates to the development and implementation of data guards for a network. In particular, the subject matter disclosed herein relates to data guards using multiple sub-element implementation repositories for maximizing unique scale quantities.

### BACKGROUND OF THE INVENTION

Enterprise level data guards within a network may provide a secure, cross domain information exchange capability. The data guards, however, may be used by hackers with the rise of zero day exploits and the speed at which these exploits are turned into tools. Thus, guards may become exploitable by bad actors unless unique guards are used. The development and deployment of such unique guards, however, is costly as small quantities are developed for an incredibly complex piece of equipment.

It may be appreciated that a need exists for the development and implementation of low cost, high yield data guards.

### SUMMARY OF THE INVENTION

The present disclosure is directed, in a first aspect, to a system for generating a guard executable for a data guard. The system includes a stitcher connected to a previous combination database and at least three repositories. The stitcher is configured to generate a random seed. The previous combinations database is configured to receive the random seed and provide a combination of implementations for the data guard to the stitcher. Each repository includes a number of unique implementations of cross domain solution functions for the data guard. The at least three repositories are configured to retrieve the combination of implementations for the stitcher. The stitcher is configured to combine the combination of implementations retrieved from the at least three repositories into a guard code base. The system also includes a compiler configured to generate the guard executable having the combination of implementations for the data guard.

In yet another embodiment, the present disclosure is directed to a system for generating a data guard executable code. The system includes a filter methods repository having a number of filter method implementations. The system also includes a deep packet analyzer repository having a number of deep packet inspection implementations. The system also includes a rules handler methods repository having a number of rules handler method implementations. The system also includes a previous combinations database having a plurality of entries of random seeds. Each of the plurality of entries corresponds to a filter method implementation within the filter methods repository, a deep packet inspection implementation within the deep packet analyzer repository, and a rules handler method implementation within the rules hander methods repository. The system also includes a stitcher to generate a random seed. The random seed matches an entry of the plurality of entries within the previous combinations database. The stitcher is configured to retrieve the filter method implementation from the filter methods repository, the deep packet inspection implementation from the deep packet analyzer repository, and the rules handler method implementation from the rules handler methods repository based on the entry matching the random seed. The stitcher is configured to combine the filter method implementation, the deep packet inspection implementation, and the rules handler method implementation to generate the guard executable code.

In yet another embodiment, the present disclosure is directed to a method for generating a guard executable for a data guard. The method includes generating a random seed by a stitcher. The method also includes receiving the random seed at a previous combinations database. The method also includes providing a combination of implementations for the data guard to the stitcher from the previous combinations database based on the random seed. The method also includes retrieving the combination of implementations from at least three repositories. Each repository includes a number of unique implementations of cross domain solution functions for the data guard. The method also includes combining the combination of implementations retrieved from the at least three repositories into a guard code base using the stitcher. The method also includes generating the guard executable having the combination of implementations for the data guard using a compiler connected to the stitcher.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 illustrates a block diagram of a system having cross domain data protection according to the disclosed embodiments.

FIG. 2 illustrates a system for configuring data guards using multiple sub-element implementation repositories according to the disclosed embodiments.

FIG. 3 illustrates a flow diagram of elements used to generate a guard code base according to the disclosed embodiments.

FIG. 4 illustrates a flowchart for using multiple sub-element implementation repositories to configure a guard executable used in a data guard according to the disclosed embodiments.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art.

Before explaining at least one embodiment of the inventive concepts disclosed herein in detail, it is to be understood that the inventive concepts are not limited in their application to the details of construction and the arrangement of the components or steps or methodologies set forth in the following description or illustrated in the drawings. In the following detailed description of the embodiments of the inventive concepts, numerous specific details are set forth in order to provide a more thorough understanding of the inventive concepts. It will be apparent to one skilled in the art, however, having the benefit of the instant disclosure that the inventive concepts disclosed herein may be practiced without these specific details.

As used herein, a letter following a reference numeral is intended to reference an embodiment of the feature or element that may be similar, but not necessarily identical, to a previously described element or feature bearing the same reference numeral, such as 1, 1a, or 1b. Such shorthand notations are used for purposes of convenience only, and should not be construed to limit the inventive concepts disclosed herein in any way unless expressly stated to the contrary.

Moreover, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of the “a” or “an” are employed to describe elements and components of embodiments of the instant inventive concepts. This is done merely for convenience and to give a general sense of the inventive concepts, and “a” and “an” are intended to include one or at least one and the singular also includes plural unless it is obvious that it is meant otherwise. It will be further understood that the terms “comprises” or “comprising,” when used in this specification, specify the presence of stated features, integers, steps, operations, elements, or components, but do not preclude the presence or addition of one or more other features, integers, steps, operations, elements, components, and/or groups thereof.

As used herein, any reference to “one embodiment,” “alternative embodiments,” or “some embodiments” means that particular element, feature, structure, or characteristic described in connection with the embodiment is included in at least one embodiment of the inventive concepts disclosed herein. The appearances of the phrase “in some embodiments” in various places in the specification are not necessarily all referring to the same embodiment, and embodiments of the inventive concepts disclosed may include one or more of the features expressly described or inherently present herein, or any combination or sub-combination of two or more such features, along with any other features that may not necessarily be expressly described or inherently present in the instant disclosure.

The inventive concepts may be described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts, or combinations of special purpose hardware and computer instructions.

Inventive concepts may be implemented as a computer process, a computing system or as an article of manufacture such as a computer program product of computer readable media. The computer program product may be a computer storage medium readable by a computer system and encoding computer program instructions for executing a computer process. When accessed, the instructions cause a processor to enable other components to perform the functions disclosed below.

In information security, a data guard is a device or system for allowing computers on otherwise separate networks to communicate, subject to configured constraints. A data guard, or a guard, aims to control the information exchange that the network communication is supporting at the business level and provides assurance that it is effective in providing this control even under attack or during failure conditions. Guards are capable of handling multiple classifications or restrictions of data as well as inspecting and recombining data based on routing or security rules.

In some instances, use of a single guard implementations in multiple locations is not feasible. Instead, bespoke guards may be used, or even required, as these implementations limit known exploits. A guard policy may limit these exposures by protecting infrastructure with multiple implementations of guards. Data and networks are protected by running the interactions through multiple layers of guards from multiple different builds.

To reduce the overall cost of developing a guard, many of the sub-elements may be shared so long as the overall implementation is changed. This feature may change the overall threat vector. Common exploits may not be used between data guards unless the attacker knows the technical details of the implementation of a specific guard. The disclosed embodiments may break each function or step of a cross domain solution (CDS) into individual elements. Multiple ways may be defined to perform each method that still satisfies the secure specification. The data guard may desire tight variable hand overs between the functions, such as provisions, returns, and inheritance. The disclosed embodiments may create these methods apart from the CDS.

A stitcher may mesh the individual methods into a guard code base that is implemented on a data guard. A program is executed across the individual methods of each function and stitched together so that the individual methods form a global group of methods to create entirely unique CDS instances. Analyzers may implement deep packet inspections and relational database inspections. Rules and interpreters may include strong conversion methods and rules read and analysis. Filter methods may include filtration and time histogram pattern evaluation.

Based upon a random number generator, a use type (military, commercial, demo), a country code, and a history of which combinations have been used previously, a combination calculation may be generated thereby creating a unique CDS that has increased usability for its given scenario. When and if the maximum number of generations have been achieved, then the commercial or demo combinations may be re-used on a limited basis. Some combinations, such as those for military uses, may not be reused at all.

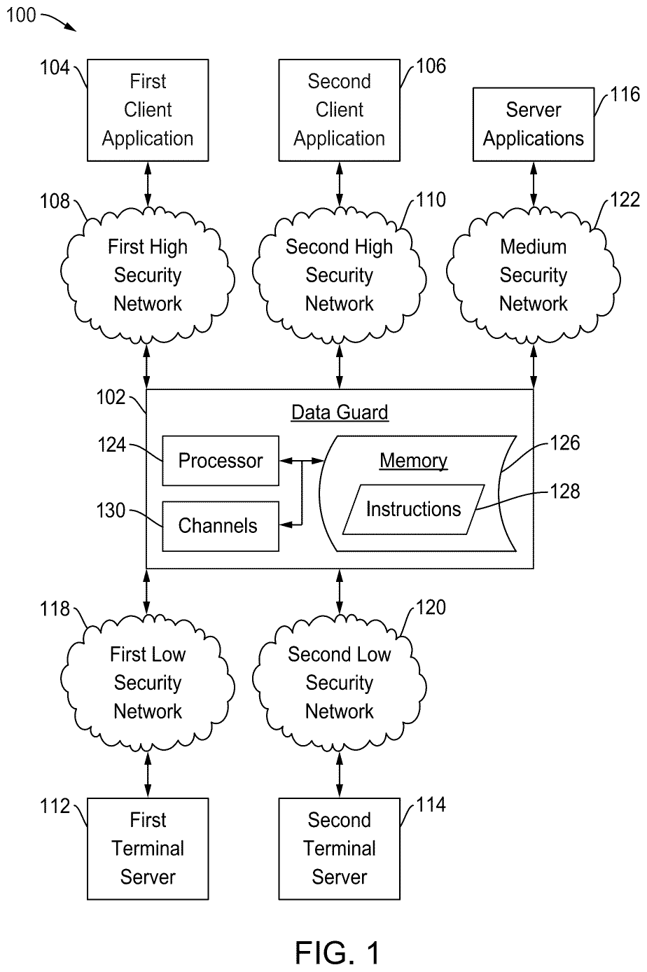

FIG. 1 depicts a block diagram of a system 100 having cross domain data protection across multiple networks according to the disclosed embodiments. System 100 may implement a cross domain solution that addresses a need for communications between different security level domains. In some instances, the number of networks and classification levels of communication continue to grow. Users need access to these different networks, including those instances where content, services, and applications of a lower clearance domain are made available to users to a domain of a higher security clearance.

System 100 may enable high-side users to exchange data or interact with low-side materials or users. For example, first high security network 108 and second high security network 110 may be on the “high-side” or secure side while first low security network 118 and second low security network 120 may be on the “low-side.” Medium security network 122 may be on one side or the other. Data guard 102 allows communication between these networks in a secure manner. The cross domain solution provided by system 100 may ensure that the high-side users are protected from low-side threats and malicious intent. System 100 makes sure that information from the high-side or high security networks does not reach the low-side networks.

For example, first client application 104 connected to first high security network 108 may initiate a file transfer from first terminal server 112 through first low security network 118. Data from first terminal server 112 may be manipulated using first client application 104 and provided back to first terminal server 112, as long as sensitive data is not present. Data guard 102 allows for a bi-directional exchange of this data. Second client application 106 connected to second high security network 110 may access second terminal server through second low security network 120.

First client application 104 and second client application 106 may access server applications 116 through medium security network 122. Server applications 116 may include applications executing as a service in a server or cloud environment. Server applications 116 may include email applications, standard applications, web sites, documents and data files, chat or message applications, and the like. In some embodiments, medium security network 122 may be considered on the low-side of system 100 with first low security network 118 and second low security network 120.

First client application 104 and second client application 106 may be configured to run as an application or applet on a workstation connected to first high security network 108 and second high security network 110, respectively. In some embodiments, applications 104 and 106 may be connected to the same network. A user can obtain access to a low-side network, such as first low security network 118, second low security network 120, or medium security network 122, using data guard 102. Once a user has authenticated through data guard 102 and established a session, the user may access applications, resources, and services that have been configured for use on first terminal server 112, second terminal server 114, or server applications 116.

Data guard 102 may be a cross-domain high-assurance device designed to enforce secure communications between the different networks within system 100. Data guard 102 may support authentication and control of all connections and accounts, perform format validation of messages to ensure that compliant communications are passed, perform further validation of content to ensure, for example, that image data is free of extensible fields, perform stateful validation of messages to pass those messages that are appropriate at that stage of a session, perform a dirty word/clean word search of all text-based content that passes between networks, perform anomaly detection and pattern detection to identify possible security issues, log all security-related events and anomalies, support auditing of sessions to include the ability to record and play back sessions, and the like.

Data guard 102 may include one or more processors 124 that execute one or more sets of instructions 128 stored in one or more memory locations 126. Instructions 128 may configure processor 124 to execute the functions disclosed herein within data guard 102. Data guard 102 may be configured to provide a multi-way, cross domain framework with certified policy enforcement and providing easily reconfigurable, user-loadable security rulesets. Data guard 102 enable information to flow simultaneously between networks of different classification levels, such as those disclosed in FIG. 1.

Data guard 102 also includes channels 130. Independent multiple levels of security (MLS) channels simultaneously bridge several security enclaves and networks. Channels 130 may be configured to allow data flow to bidirectional, unidirectional, or all-way for each of the channels. Using these features, data guard 102 is able to process standard and nonstandard messages as well as other non/semi-formatted file types. The cross domain framework ensures quick reconfiguration to a variety of target applications. In some embodiments, the number of channels 130 may be up to ten channels with one channel for management control.

Instructions 128 may include a guard executable file which is a cross domain solution compiled executable by data guard 102 to perform the functions to provide the services across the networks within system 100. An implementation of the guard executable file may not be feasible across multiple locations within system 100. As disclosed above, such a situation may result in data guard 102 being compromised. For example, a first data guard 102 between first high security network 104 and first low security network 118 and medium security network 122 and a second data guard 102 between second high security network 106 and second low security network 120 and medium security network 122 should not use the same guard executable file. Compromising the first data guard would allow one to compromise the second data guard. If the files differ, however, then one data guard being compromised would not lead to the compromising of other data guards within system 100.

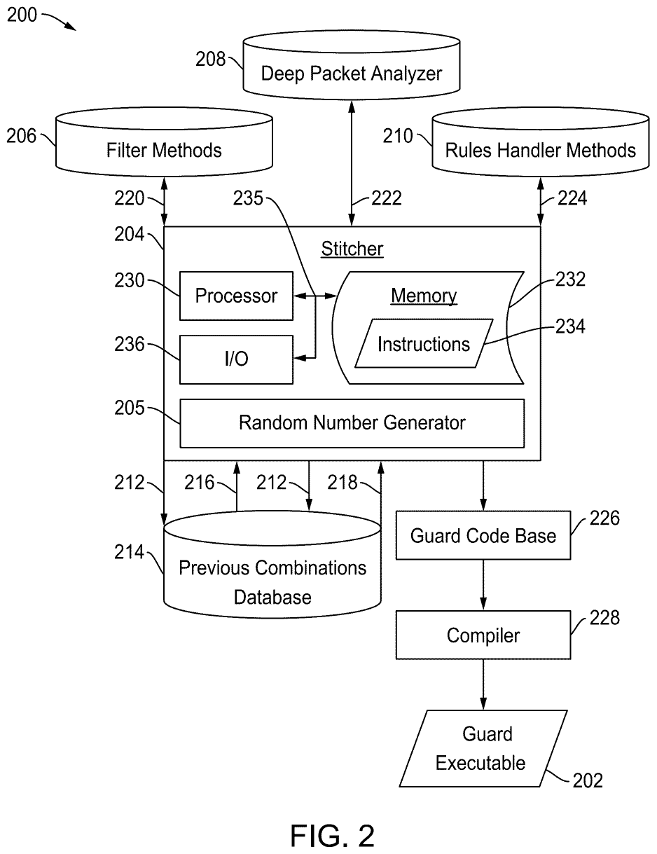

FIG. 2 depicts a system 200 for configuring data guards using multiple sub-element implementation repositories according to the disclosed embodiments. System 200 may separate each function or step of a CDS into individual elements. These individual elements may be stored a plurality of sub-element implementation repositories. In some embodiments, the repositories are databases for storing methods and functions executable by data guard 102.

For example, the repositories may include filter methods 206, deep packet analyzer 208, and rules handler methods 210. Each repository may have 5-10 implementations to provide in data guard 102. The combination of these sub-elements may be compiled into guard executable 202. Referring back to FIG. 1, guard executable 202 may be implemented in instructions 128, which are executed using one or more processors 124. Processors 124 configure data guard 102 to execute the sub-element implementations within guard executable 202.

Stitcher 204 includes a random number generator 205 that produces a random seed 212. Random number generator 205 may generate numbers in a manner that is fundamentally unpredictable and non-deterministic. Random number generator 205 may rely on a physical process to generate randomness. For example, random number generator 205 may use electronic noise in an electronic component that is captured and digitized to produce random numbers. Any analog signal may be converted into a digital form. The digital form may be post-processed to ensure the generated numbers are uniformly random and not biased. Random number generator 205 outputs random seed 212 that is a sequence of numbers such that each number is unpredictable and should not follow any deterministic pattern. In some embodiments, random number generator 205 may be enabled by a microcontroller configured to execute the processes disclosed above.

Stitcher 204 sends random seed 212 to previous combinations database 214. Database 214 checks its records to determine whether the random seed 212 has been used before. Database 214 stores data whether seeds have been used previously having the combinations of the sub-elements from the repositories. If so, then database 214 returns an already used rejection 216 back to stitcher 204. Stitcher 204 instructs random number generator 205 to generate a new random seed 212 that is provided to database 214. This process may be executed until random number generator 205 generates a random seed 212 that has not been used previously as determined by database 214.

If random seed 212 has not been used previously, then database 214 stores random seed 212 and responds with an acceptance 218 of the random seed plus the specific identifications of the implementations to use from the different repositories. For example, database 214 selects an implementation from filter methods 206, an implementation from deep packet analyzer 208, and an implementation of rules handler methods 210. These implementations may be randomly selected based on random seed 212 as the seed has not been previously used. Random seed 212 may be sliced to select an implementation from each repository.

Acceptance 218 provides the identifications of the specific implementations to stitcher 204. Stitcher 204 sends retrieval instructions to the different repositories to retrieved the identified implementations for the random order corresponding to random seed 212. Retrieval instructions are based on random seed 212 and may include data from the random seed that indicates which implementation to retrieve from filter methods 206, deep packet analyzer 208, and rules handler methods 210.

The implementations, as functions or methods to be used by data guard 102, define multiple ways to perform each function or method that still satisfies the requirements for the data guard. Different teams may develop each implementation apart from each other and apart from system 100. The number of implementations in each repository may be increased or scaled as requirements change for configuring data guards 102. Further, implementations may be removed or updated with new implementations. For example, filter methods 206 may include 10 different implementations. Two new implementations may be developed such that the number of implementations of filter methods 206 is increased to 12, or 2 current implementations are removed from filter methods 206.

The repositories respond the randomly selected implementations from their libraries to stitcher 204. For example, filter methods 206 may provide a filter method 220. Deep packet analyzer 208 may provide a deep packet inspection 222. Rules handler methods 210 may provide a rules handler method 224. These implementations should not have been used yet in configuring a data guard 102.

Stitcher 204 combines filter method 220, deep packet inspection 222, and rules handler method 224 into guard code base 226. The implementations, as sub-elements, are combined within stitcher 204 as source code elements. This feature aligns with any tight input/output parameters. Guard code base 226 should be unique from previous guard code bases generated by stitcher 204. Stitcher 204 may modify the elements to be combined as code, executable on a data guard 102.

Compiler 228 receives the source code elements of guard code base 226 to generate guard executable 202 for a data guard 102. Compiler 228 checks for any possible errors in executing guard code base 226. For example, compiler 228 may check guard code base 226 for any possible syntax and semantic errors caused within the elements themselves or in their combination by stitcher 204. Compiler 228 may translate guard code base 226 into code that is executable by a data guard 102 as guard executable 202.

Guard executable 202 then is ready to be downloaded into a data guard 102, such as being stored in memory 126. The resultant documentation also may be generated that may be run through the proper certifications and approval processes by the managers of system 100. In other words, before guard executable 202 can be implemented, it should be reviewed so that it is acceptable for handling communications between different networks, including those with high-level or high security access.

Stitcher 204 may be executed on a one or more processors 230 using instructions 234 stored in memory 232. Processor 230 may load instructions 234, as code, and executes the code to perform one or more features disclosed above. Stitcher 204 also may include a data bus 235 that moves data within the stitcher between components. Stitcher 204 also may include an input/output module 236 to communicate with database 214, compiler 228, and the repositories of filter methods 206, deep packet analyzer 208, and rules handler methods 210. One or more processors 230 also may be dedicated to enabling random number generator 205 within stitcher 204.

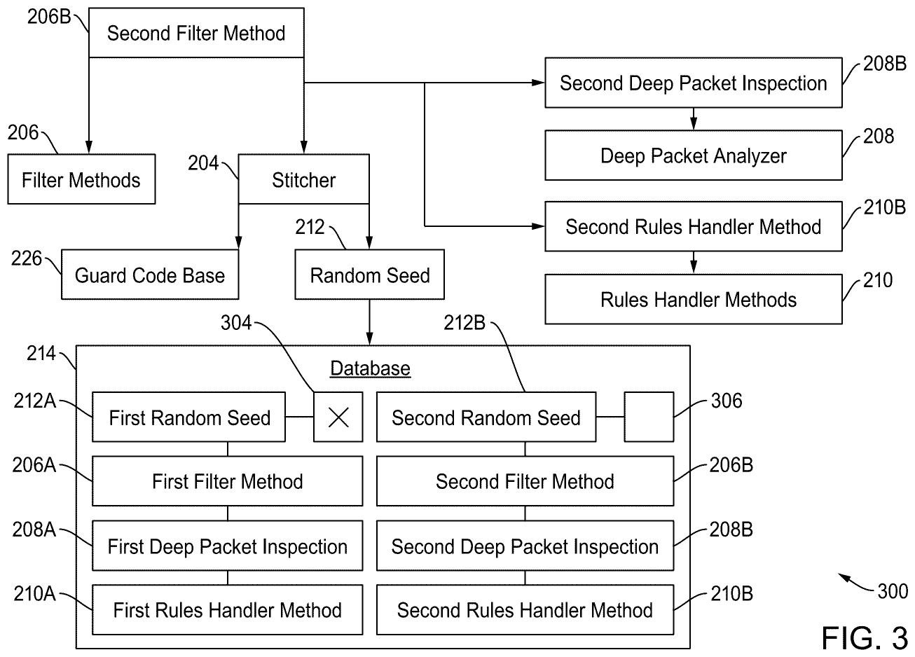

FIG. 3 depicts a flow diagram 300 of elements used to generate guard code base 226 according to the disclosed embodiments. As disclosed above, random number generator 205 of stitcher 204 generates random seed 212. Random seed 212 is provided to previous combinations database 214. Database 214 includes entries of previous random seeds used by system 200 along with the elements from each repository used in creating a guard executable 202.

For example, database 214 includes an entry for a first random seed 212A. First random seed 212A may be associated with first filter method 206A of filter methods 206, first deep packet inspection 208A, and first rules handler method 210A. First filter method 206A may be one of a number of elements for implementations of filter methods available for use within data guard 102. First deep packet inspection 208A may be one of a number elements for implementations of deep packet inspections available for use within data guard 102. First rules handler method 210A may one of a number of elements for implementations of rules handler methods available for use within data guard 102.

Indicator 304 may indicate whether first random seed 212A has been used already in a guard code base 226 for a guard executable 202. Indicator 304 may be a field, flag, metadata, bit, or other means for indicating that a random seed has been used previously. Database 214 may compare random seed 212 to first random seed 212A and determine that the combination of elements using first filter method 206A, first deep packet inspection 208A, and first rules handler method 210A has been used previously in a guard executable for a previous data guard. Thus, this combination should not be used in a subsequent data guard. Database 214 informs stitcher 204 that the current random seed has already been used.

Random number generator 205 generates a new random seed 212. The new random seed may match second random seed 212B stored in database 214. Indicator 306 of second random seed 212B indicates that its combination of elements have not been used in a data guard 102. Thus, the combination is available for use in creating guard code base 226.

Database 214 returns instructions to stitcher 204 that the new random seed 212 is available along with the identifications for the elements associated with the second random seed. In this instance, database 214 returns identifications for second filter method 206B, second deep packet inspection 208B, and rules handler method 210B. Indicator 306 may be changed to indicate that second random seed 212B is used. In some embodiments, one or two elements associated with second random seed 212B may be the same as ones used by first random seed 212A but all elements are not the same.

Stitcher 204 uses the identifications for the elements to retrieve the respective element from the repositories. Thus, second filter method 206B is retrieved by filter methods 206. Second deep packet inspection 208B is retrieved from deep packet analyzer 208. Second rules handler method 210B is retrieved from rules handler method 210. In some embodiments, database 214 may be populated with entries for the different random seeds along with the unique combination of each element of each repository.

This feature allows the combination of elements to be provided to stitcher 204 without having to determine which implementation to use. Random number generator 205 may be configured to generate a number that is within the range of the number of entries. For example, if each repository includes 10 elements, then rando number generator 205 may generate a number between 1 to 1000 as 1000 different combinations may be used.

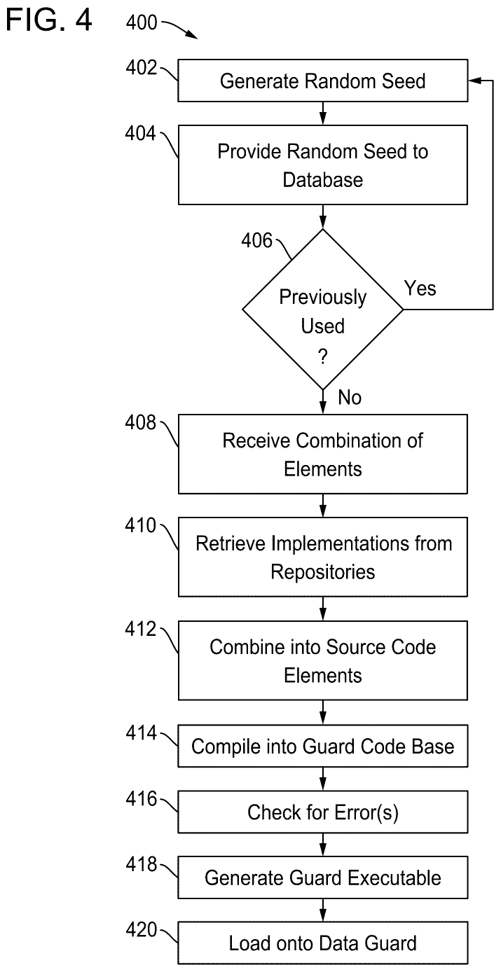

FIG. 4 depicts a flowchart 400 for using multiple sub-element implementation repositories to configure a guard executable 202 used in a data guard 102 according to the disclosed embodiments. Flowchart 400 may refer to FIGS. 1-3 for illustrative purposes. Flowchart 400, however, is not limited to the embodiments disclosed by FIGS. 1-3.

Step 402 executes by generating random seed 212 using random number generator 205 of stitcher 204. Random seed 212 should correspond to an entry within previous combinations database 214. Step 404 executes by providing random seed 212 to database 214 from stitcher 204. Step 406 executes by determining whether random seed 212 has been previously used by stitcher 204. Database 214 may check whether the corresponding entry for random seed 212 indicates that the random seed and its combination of elements have been used. If yes, then flowchart 400 returns to step 402 to generate another random seed.

If step 406 is no, then step 408 executes by receiving the combination of elements associated with random seed 212 in database 214 at stitcher 204. At least one implementation associated with an element from each repository of implementations is associated with the random seed entry. Step 410 executes by retrieving the implementations from the repositories. For example, referring to second random seed 212B shown in FIG. 3, stitcher 204 retrieves second filter method 206B from filter methods 206, second deep packet inspection 208B from deep packet analyzer 208, and second rules handler method 210B from rules handler methods 210.

Step 412 executes by combining the retrieved implementations of elements by stitcher 204 into source code elements. Step 414 executes by compiling the source code elements of the retrieved implementations into guard code base 226. Step 416 executes by checking guard code base 226 for one or more errors using compiler 228. Step 418 executes by generating guard executable 202 of the combined implementations of elements from compiler 228. Step 420 executes by loading a data guard 102 with guard executable 202. Flowchart 400 then may be repeated for the next data guard to be used within system 100.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A system for generating a guard executable for a data guard, the system comprising:
a stitcher connected to a previous combinations database and at least three repositories, wherein the stitcher is configured to generate a random seed;
the previous combinations database is configured to receive the random seed and provide a combination of implementations for the data guard to the stitcher;
wherein each repository includes a number of unique implementations of cross domain solution functions for the data guard, wherein the at least three repositories are configured to retrieve the combination of implementations for the stitcher;
wherein the stitcher is configured to combine the combination of implementations retrieved from the at least three repositories into a guard code base; and
a compiler configured to generate the guard executable having the combination of implementations for the data guard.

2. The system of claim 1, wherein the at least three repositories include a filter methods database.

3. The system of claim 1, wherein the at least three repositories include a deep packet analyzer database.

4. The system of claim 1, wherein the at least three repositories include a rules hander database.

5. The system of claim 1, wherein the compiler is configured to check the guard code base for errors.

6. The system of claim 1, wherein the stitcher includes a random number generator to generate the random seed.

7. The system of claim 6, wherein the previous combinations database includes a plurality of entries, wherein the random seed corresponds to an entry having the combination of implementations.

8. A system for generating a data guard executable code comprising:
a filter methods repository having a number of filter method implementations;
a deep packet analyzer repository having a number of deep packet inspection implementations;
a rules handler methods repository having a number of rules handler method implementations;
a previous combinations database having a plurality of entries of random seeds, wherein each of the plurality of entries corresponds to a filter method implementation within the filter methods repository, a deep packet inspection implementation within the deep packet analyzer repository, and a rules handler method implementation within the rules handler methods repository; and
a stitcher to generate a random seed, wherein the random seed matches an entry of the plurality of entries within the previous combinations database,
wherein the stitcher is configured to retrieve the filter method implementation from the filter methods repository, the deep packet inspection implementation from the deep packet analyzer repository, and the rules handler method implementation from the rules handler methods repository based on the entry matching the random seed,
wherein the stitcher is configured to combine the filter method implementation, the deep packet inspection implementation, and the rules handler method implementation to generate the data guard executable code.

9. The system of claim 8, wherein the stitcher includes a random number generator to generate the random seed.

10. The system of claim 8, further comprising a compiler to generate a guard executable for a data guard based on the data guard executable code.

11. The system of claim 10, where the compiler checks the data guard executable code for at least one error within the combined implementations.

12. The system of claim 8, wherein the previous combinations database is configured to indicate that the random seed for the entry is used.

13. The system of claim 8, wherein the number of filter method implementations stored within the filter methods repository relates to filter methods for a data guard.

14. The system of claim 8, wherein the number of deep packet inspection implementations stored within the deep packet analyzer repository relates to deep packet inspections for a data guard.

15. The system of claim 8, wherein the number of rules handler method implementations stored within the rules handler methods repository relates to rules handler methods for a data guard.

16. A method for generating a guard executable for a data guard, the method comprising:
generating a random seed by a stitcher;
receiving the random seed at a previous combinations database;
providing a combination of implementations for the data guard to the stitcher from the previous combinations database based on the random seed;
retrieving the combination of implementations from at least three repositories, wherein each repository includes a number of unique implementations of cross domain solution functions for the data guard;
combining the combination of implementations retrieved from the at least three repositories into a guard code base using the stitcher; and
generating the guard executable having the combination of implementations for the data guard using a compiler connected to the stitcher.

17. The method of claim 16, wherein generating the random seed includes generating the random seed using a random number generator within the stitcher.

18. The method of claim 16, further comprising checking for at least one error within the combination of implementations using the compiler.

19. The method of claim 16, further comprising indicating the random seed has not been previously used based on an entry corresponding to the combination of implementations.

20. The method of claim 16, wherein the at least three repositories include a filter methods repository, a deep packet analyzer repository, and a rules handler methods repository.
